(19) United States
(12) Patent Application Publication
(10) Pub. No.: US 2005/0140363 A1
(43) Pub. Date: Jun. 30, 2005

(54) Sensor for detection of the orientation of a magnetic field

(75) Inventors: Hubert Grimm, Mommenheim (DE); Johannes Paul, Mainz (DE); Rolf Schaefer, Walluf (DE)

Correspondence Address: James R. Nock;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/941,416

(22) Filed: Sep. 15, 2004

(30) Foreign Application Priority Data
Dec. 29, 2003 (DE) 03104990.1

(51) Int. Cl. G01B 7/14

(52) U.S. Cl. 324/207.21

(57) ABSTRACT

A magnetic sensor having at least a first and a second magnetoresistive element being non-parallel provides determination of the direction of a magnetic field. The at least first and second magnetoresistive elements are positioned along at least a first and a second elongated gap each of which separating at least a first and a second closely spaced planar area of soft-magnetic material serving as flux guides. The flux guides provide amplification of magnetic field components being perpendicular to the elongated direction of each gap. A variety of various magnetoresitive elements such as AMR elements or GMR-multilayer systems can effectively be used in order to detect the magnitude and/or the direction of the magnetic field. By appropriately designing the geometry of the flux guides, direction dependent gain factors can effectively be realized. This allows for a large detection range and sensitivity of the magnetic sensor.

### FIELD OF THE INVENTION

The present invention relates to the field of detection of the orientation of a magnetic field and more particularly to the detection of an angular position of a rotatable element.

### DESCRIPTION OF THE RELATED ART

The contactless determination of angular positions of a rotatable element can effectively be realized by making use of detecting the direction of a magnetic field characterizing the angular position of the rotatable element. By determining the direction of the magnetic field with the help of a magnetic sensor, the angular position of the rotatable element can be determined in a contactless way. Magnetic sensors known in the prior art predominantly make use of the Hall effect or some type of magnetoresistive effect.

Making use of a magnetoresistive effect, a magnetic field that varies with the angle of rotation of a rotatable element can effectively be measured by means of a plurality of magnetoresistive elements featuring an electric resistance depending on the strength and/or orientation of an external magnetic field. In order to determine the direction of an external magnetic field, most typically four magnetoresistive elements are interconnected to form a bridge circuit in particular in form of a Wheatstone bridge.

U.S. Pat. No. 6,433,535 B1 describes an arrangement for detecting the angle of rotation of a rotatable element. This sensor arrangement makes use of two Wheatstone bridges having isotropic magnetoresistance thin film sensors or AMR gauge strips. The electrical resistance of AMR materials, such as Permalloy, depends on the angle between the direction of magnetization, or the direction of an applied magnetic field and the direction of an electric current flowing through the AMR materials. Furthermore, in this arrangement the respective bridge branches of the Wheatstone bridges each have two AMR gauge strips in which current directions extending perpendicular to one another.

While the current direction is dictated by the geometry of the AMR gauge strips, the direction of magnetization is a function of the direction of the external magnetic field to be detected. The angular dependency of the electrical resistance of the AMR gauge strips has a 180° periodicity; the resistance is maximal when the direction of magnetization is parallel or anti-parallel to the current direction, and it is minimal when the direction of magnetization is perpendicular to the current direction.

A variation of the relative angle between the current direction and the direction of the external magnetic field directly reflects in a variation of the electric resistance of the AMR material. Even though magnetic field sensors based on AMR materials are obviously advantageous for the determination of the orientation of a magnetic field, these sensors typically exhibit only a rather low output signal which is disadvantageous for subsequent signal processing.

In contrast to AMR materials, GMR-multilayer systems provide a rather large output signal. A giant magnetoresistance (GMR)-multilayer system typically features a plurality of adjacent ferromagnetic layers that are aligned in an antiparallel way by antiferromagnetic coupling. The giant magnetoresistive effect has a magnetization dependent component of resistance that varies as the cosine of the angle between magnetizations in two ferromagnetic layers on either side of an intermediate layer. The electrical resistance of a GMR-multilayer system is lower if the magnetizations in the two separated ferromagnetic layers are parallel than it is if these magnetizations are antiparallel, i.e. directed in opposing directions.

In contrast to an AMR effect, the GMR-effect is not depending on the direction of a sensing current. Hence, it is not straightforward to detect the direction of an externally applied magnetic field by means of a GMR-multilayer system. For example, by applying a rather strong magnetic field in plane to a GMR-multilayer system, both initially anti-parallel aligned ferromagnetic layers will align in a direction parallel to the externally applied magnetic field. As a result of such a mutually parallel alignment, the electrical resistance of the GMR-multilayer system drops to its minimum value. For example, turning the external magnetic field in a perpendicular in-plane direction leads to the same parallel alignment of the two ferromagnetic layers resulting in the same minimum electrical resistance of the GMR-multilayer system.

Furthermore, a magnetic sensor on the basis of a GMR-multilayer system features a rather high output signal on the expense of a relatively low minimum detection field. However, this drawback can be compensated by making use of flux amplification by means of flux guides. A flux guide typically consists of a soft-magnetic material that is characterized by a magnetic permability significantly higher than that of free space, and which cannot be permanently magnetized to a significant degree.

These properties allow soft-magnetic materials to conduct magnetic flux in much the same way as copper wires are used to conduct electric currents. Common examples of soft-magnetic materials are pure iron and nickel-iron steels such as Permalloy, FeAIN, CoFe, CoZrTa.

Flux guides are useful in magnetic sensors because they allow a more arbitrary design to channel magnetic flux than that provided by free space. This provides the following major benefit. A flux guide can be used to concentrate and increase the detectable flux levels, hence to increase the magnetic field to be sensed by a sensor. Due to this benefit, flux guides are commonly used in combination with GMR-multilayer systems in order to control and to design the range of and the sensitivity of a magnetic sensor.

There is a need to provide a magnetic sensor for detecting the direction of a magnetic field by making use of flux guides in combination with magnetoresistive elements, in particular GMR-multilayer systems.

### SUMMARY OF THE INVENTION

The present invention provides a sensor for determining the direction of a magnetic field. The inventive sensor comprises a soft-magnetic planar structure with at least a first and a second area being separated by at least a first and a second elongated gap, the first and the second elongated gaps being non-parallel. The at least first and second gap strictly separate the at least first and second area of the planar soft-magnetic structure. Therefore, the first and the second areas are not contacted.

The inventive sensor further comprises at least a first and a second magnetoresistive element, the first magnetoresistive element being positioned along the first elongated gap and the second magnetoresistive element being positioned along the second elongated gap. Both magnetoresistive elements are adapted to be electrically connected to a source of electrical energy and being further adapted to be electrically connected to an electrical measurement unit.

The at least first and second area of the soft-magnetic planar structure serve as flux guides in order to concentrate and to increase the detectable flux levels. Since the at least first and second areas of the planar structure are separated by at least a first and a second elongated gap, the magnetic field inside the elongated gaps is substantially larger than the externally applied magnetic field. The gain factor of a flux guide is proportional to the length of the flux guide divided by the size of the gap between the flux guides. Furthermore, when the gaps between the first and the second area, hence between the single flux guides is small compared to the dimensions of the flux guides, the direction of the magnetic field inside the gap is substantially perpendicular to the elongated direction of the gap.

The magnitude of the magnetic field inside the gap also strongly depends on the direction of the magnetic flux in the planar structure. In principle, only the component of an externally applied magnetic field vector pointing in a perpendicular direction with respect to the elongated direction of the gap experiences an appreciable amplification by the arrangement of two adjacently spaced flux guides being closely separated by a gap.

For example, when the external magnetic field is applied along the elongated direction of a gap, the magnetic field inside this gap is lower than the externally applied magnetic field. It is substantially reduced because of a shielding effect provided by the flux guide configuration. In the opposite case, when the externally applied magnetic field points in a direction perpendicular to the elongated direction of the gap, the magnetic field inside the gap experiences a maximum amplification through the configuration of adjacently positioned flux guides.

Having at least two flux guides that are separated by at least a first and a second elongated gap that are non-parallel and having further a first and a second magnetoresistive element positioned along the first and the second elongated gap, in each gap the magnetic field component pointing in the perpendicular direction with respect to the elongated direction of the gap can be effectively determined by means of the magnetoresistive elements. Since the first and the second elongated gaps are non-parallel, and since the two detectors are oriented with respect to the direction of each gap and further determine the magnitude of an externally applied magnetic field component being perpendicular to the elongated direction of the gap, the direction of the externally applied magnetic field can easily be determined by comparing the magnitude of the perpendicular magnetic field components of each gap.

In this way, the first and/or the second magnetoresistive elements that are positioned along the two elongated gaps only have to detect the magnitude rather than the direction of the magnetic field inside each gap. By connecting the first and the second magnetoresistive elements to a source of electrical energy and further connecting the at least two magnetoresistive elements to an electrical measurement unit, the electrical resistance of each magnetoresistive element can be determined and the magnitude of the perpendicular magnetic field component inside each gap can effectively be measured.

For example, the first and the second elongated gaps between the first and the second area of the soft-magnetic planar structure, the flux guides, are oriented in a substantially perpendicular way such that the first gap points in the x-direction and the second gap points in the y-direction. Applying an external magnetic field in the x-direction leads to a corresponding magnetization of both flux guides. As a consequence the magnetic field component pointing in the x-direction is maximally amplified in the second gap by this configuration of flux guides, whereas this component of the externally applied magnetic field is reduced inside the first gap.

Assuming further, that the externally applied magnetic field is homogeneous over the entire soft-magnetic planar structure, the resistance of the two magnetoresistive elements tend to become minimal and maximal, respectively.

When for example the first and the second magnetoresistive element are a GMR-multilayer system, the resistance of the first element pointing in the x-direction is maximal, whereas the electric resistance of the second magnetoresistive element pointing in the y-direction and hence being subject to a rather large perpendicular magnetic field component tends to minimize.

According to a further preferred embodiment of the invention, the geometric structure of the at least first and second elongated gap, hence the geometry of the single flux guides of the soft-magnetic planar structure, can be arbitrarily chosen. In this way the gain factor provided by the flux guides can be adapted and designed individually for each elongated gap between the at least first and second flux guides. Since the elongated gaps and the magnetoresistive elements are arranged non-parallel, the electrical resistance of each magnetoresistive element is indicative of different components of the externally applied magnetic field. Due to the fact, that the gain factor of an arrangement of flux guides depends on the geometry of the single flux guides and the separation between the single flux guides forming the gap, different gain factors can individually be designed for the different elongated gaps.

Having for example two elongated gaps pointing in the x- and y-direction that are formed by a variety of closely separated flux guides having different dimensions along the x- and y-direction, the gain factor of the magnetic field inside the two gaps differs appreciably. In this way the inventive sensor can individually be designed in order to provide different measurement sensitivities for different directions of an externally applied magnetic field.

According to a further preferred embodiment of the invention, the at least first and second areas of the soft-magnetic planar structure have a point of contact in such a way, that the at least first and second gaps represent a first and a second groove in the soft-magnetic planar structure. The at least first and second magnetoresistive elements being positioned along the at least first and second groove of the soft-magnetic planar structure. Here, the grooves act in a similar flux-amplifying way as the gaps separating two individual areas of the soft-magnetic structure.

Generating at least two grooves in a soft-magnetic material instead of creating at least a first and a second gap separating at least two areas of soft-magnetic material, is especially advantageous for an efficient and low-cost manufacturing process. In contrast to the generation of gaps, where the individual areas have to be properly positioned and fixed, a groove can easily be generated by means of some etching or ablation procedure being applied to the soft-magnetic planar structure.

According to a further preferred embodiment of the invention, the at least first and second magnetoresistive elements are adapted to provide at least one electrical signal to the electrical measurement unit. This at least one electrical signal is indicative of the relative angle between the direction of the magnetic field and the orientation of the at least first and second magnetoresistive elements. By connecting the at least two magnetoresistive elements to a source of electromagnetic energy, the electrical resistance of each magnetoresistive element can effectively be measured for example by means of a voltage drop across each magnetoresistive element.

In this way the electrical resistance of the magnetoresistive element is represented by an electrical signal. Since the electrical resistance of the magnetoresistive elements indicates the relative direction between the externally applied magnetic field and the orientation of the a least two magnetoresistive elements, as a consequence, the electrical signal is also indicative of the relative angle between the magnetoresistive elements and the externally applied magnetic field. Having knowledge about the absolute and relative orientation of the first and the second magnetoresistive element, the absolute direction of the externally applied magnetic field can be determined.

According to a further preferred embodiment of the invention, the soft-magnetic planar structure comprises four soft-magnetic areas of rectangular shape being closely and adjacently spaced forming a first and a second pair of elongated gaps.

Each pair of elongated gaps has two substantially parallel oriented and oppositely positioned elongated gaps, and the first and the second pair of gaps being oriented substantially perpendicular with respect to each other. In each of the four gaps a magnetoresistive element is positioned along the direction of elongation of each gap. When for example, the four soft-magnetic areas of rectangular shape; i.e., the flux guides, even have a quadratic geometry and further feature equal spacing, thus forming four gaps of identical geometry and elongation, the magnetoresistive elements are positioned in a pair of parallel oriented and oppositely positioned elongated gaps, wherein each magnetoresistive element of a pair of elements provides the same output signal.

In this way, output signals of parallel oriented magnetoresistive elements can be compared in order to improve the accuracy of the sensor. When for example the flux guides all feature the same non-quadratic but rectangular shape, the gain factor for parallel oriented gaps will be equal but differ between the two perpendicular oriented pairs of gaps. In this way the sensor is designed to have a different sensitivity along two perpendicular directions.

According to a further preferred embodiment of the invention, four magnetoresistive elements being positioned along four gaps separating four closely spaced soft-magnetic areas of rectangular shape are electrically interconnected to form a bridge circuit that is further adapted to provide an electrical signal being indicative of a difference between two substantially perpendicular components of the applied magnetic field. When for example the four magnetoresistive elements are pairwise parallel and oppositely positioned along the elongated gaps and when the two pairs of magnetoresistive elements are oriented substantially perpendicular with respect to each other, it is of advantage to realize the bridge circuit as a Wheatstone bridge.

In such a Wheatstone bridge arrangement, a first magnetoresistive element is connected to a second and third magnetoresistive element, the first magnetoresistive element being substantially oriented perpendicular with respect to the second and third magnetoresistive element, the third and second magnetoresistive element being substantially parallel. The second and third magnetoresistive elements are further connected to a forth magnetoresistive element being substantially oriented perpendicular to the second and third magnetoresistive element. The first and fourth magnetoresistive elements being substantially parallel but are electrically connected only via the second and the third magnetoresistive element. The four elements are forming a Wheatstone bridge.

Supplying such a bridge circuit with electrical energy, a voltage drop across two mutually perpendicularly oriented magnetoresistive elements is directly indicative of the difference of the electrical resistance between the two magnetoresistive elements. In this way, a single electrical signal is directly indicative of the relative angle between the externally applied magnetic field and the magnetoresistive elements.

For example, when two of the four gaps and their corresponding magnetoresistive elements are oriented in the x-direction and the remaining two gaps and their corresponding magnetoresistive elements are oriented in the y-direction, the electrical signal is directly indicative of the difference between the magnitude of the y-component and the x-component of the externally applied magnetic field. When for example the direction of the externally applied magnetic field has a 45° angle with respect to the x- and y-direction, the electrical signal will be equal to zero when the gain factors of the four gaps between the single flux guides are equal. Rotating the externally applied magnetic field or rotating the sensor with respect to a fixed externally applied magnetic field by 45° in either direction leads to a maximum and minimum electrical signal, respectively.

According to a further preferred embodiment of the invention, the magnetoresistive elements either exhibit a GMR an AMR or a tunnelmagnetoresistive (TMR) effect. The output characteristics of ordinary AMR or GMR elements is omnipolar, meaning that the material provides the same change in resistance for a directionally positive magnetic field as it does for a directionally negative field. Making use of these types of magnetoresistive elements generally limits the range for unequivocal determination of a direction of the externally applied magnetic field from 00 to 90°° Making use of the above mentioned bridge circuit in form of a Wheatstone bridge provides an electrical signal featuring four zero crossings for one full revolution of the externally applied magnetic field. Magnetoresistive elements of various types; e.g., of stripe or meander type can universally be applied in the inventive sensor.

In another aspect of the present invention, the soft-magnetic structure of the sensor may also comprise only one area with at least two edges that are non-parallel. Compared to the above described arrangement, the first and the second edge have a similar functionality than the first and the second gap. A first magnetoresistive element being closely positioned along the first edge and a second magnetoresistive element being closely positioned along the second edge. Both, first and second magnetoresistive elements are adapted to be electrically connected to a source of electrical energy and to an electrical measurement unit.

In this configuration the area of the soft-magnetic structure serves as flux guide providing a gain factor for the magnetic flux that can most effectively be detected in close proximity to the edges of the area by means of the magnetoresistive elements. This aspect provides an effective and alternative way to detect the magnitude of non-parallel components of a magnetic field.

In another aspect of the present invention, a sensor device for determining the direction of a magnetic field can be generated comprising at least a first and a second inventive sensor. The first and the second sensors being arranged in parallel planes in such a way that the first and the second sensor are rotated with respect to each other. When for example the first and the second detector feature a comparable geometry of flux guides and gaps between flux guides, the two sensors can be mutually rotated by an angle such that their magnetoresistive elements are non-parallel. In such a configuration, by comparing an at least first electrical signal of the first magnetic sensor with an at least second electric signal of the second magnetic sensor, the range over which the rotation angle can unequivocally be determined can effectively be extended from 00 to 180°.

In a further aspect of the invention, a signal processing system determines the direction of the externally applied magnetic field. The signal processing system comprising signal processing means for determining the direction of the magnetic field by processing of an electrical signal provided by the electrical measurement unit. The electrical measurement unit is further adapted to be electrically connected to at least a first and a second magnetoresistive element, the first magnetoresistive element being positioned along a first elongated gap of a soft-magnetic planar structure and the second magnetoresistive element being positioned along a second elongated gap of a soft-magnetic planar structure, the first and the second elongated gaps being non-parallel.

The signal processing means of the signal processing system determine the direction of the magnetic field by making use of a function being descriptive of the relation between an angle of rotation and the electrical signal provided by the electrical measurement unit. Alternatively the signal processing means make use of a predefined reference table assigning the electrical signal to an angular position.

According to a further preferred embodiment of the invention, the signal processing system further comprising means for detecting a zero crossing of the electrical signal. Making use of a bridge circuit, and in particular of a Wheatstone bridge interconnecting four magnetoresistive elements, in particular GMR-multilayer systems by detecting the zero crossings of the electrical signal, the signal processing system in combination with the inventive sensor provides a rev meter. Simply by counting the zero crossings of the electrical signal, the signal processing system determines the revolutions per minute of a rotatable element having attached a source of magnetic field whose direction can be detected by the detector.

According to a further preferred embodiment of the invention, the signal processing system comprising input means for a modification of the signal processing means. Since the geometry of the soft-magnetic planar structure can be arbitrarily designed in order to provide specific gain factors for the various gaps between the flux guides, the processing of the resulting electrical signals also has to account for changes of the gain factors. With the help of the input means, the signal processing means can be arbitrarily modified in order to account for a modified geometry of the flux guides.

In still another aspect, the invention provides a computer program product for determining the direction of a magnetic field. The computer program product comprising program means for calculating the direction of the magnetic field from an electrical signal provided by an electrical measurement unit. The electrical measurement unit is adapted to be electrically connected to at least a first and a second magnetoresistive element. The first magnetoresistive element is positioned along a first elongated gap of a soft-magnetic planar structure and the second magnetoresistive element is positioned along a second elongated gap of the soft-magnetic planar structure, the first and the second elongated gaps being non-parallel.

The present invention therefore provides a magnetic sensor and a magnetic sensor device as well as a signal processing system for the determination of the direction of a magnetic field. Preferably the source of the magnetic field is attached to a rotatable element and the direction of the magnetic field rotates with the angular movement of the rotatable element. Since the sensor determines the direction of the magnetic field, the angular position of the rotatable element can be determined. The inventive sensor makes further use of a gain effect provided by an arrangement of flux guides amplifying selected components of the applied magnetic field. Due to the geometric arrangement of magnetoresistive elements and flux guides, various components of a magnetic field can directly be determined and compared in order to determine the direction of the magnetic field.

### BRIEF DESCRIPTION OF THE DRAWINGS

In the following, preferred embodiments of the invention will be described in greater detail by making reference to the drawings in which:

FIG. 1 shows four electrically inter-connected magnetoresistive elements;

FIG. 2 shows the magnetoresistive elements of FIG. 1 and additional flux guides;

FIG. 3 shows a connection diagram of the magnetoresistive elements;

FIG. 4 shows a diagram of a measured electrical signal versus rotation angle; and

FIG. 5 shows a magnetic field sensor with a single flux guide.

### DETAILED DESCRIPTION OF THE PREFERRED EMBODIMENTS

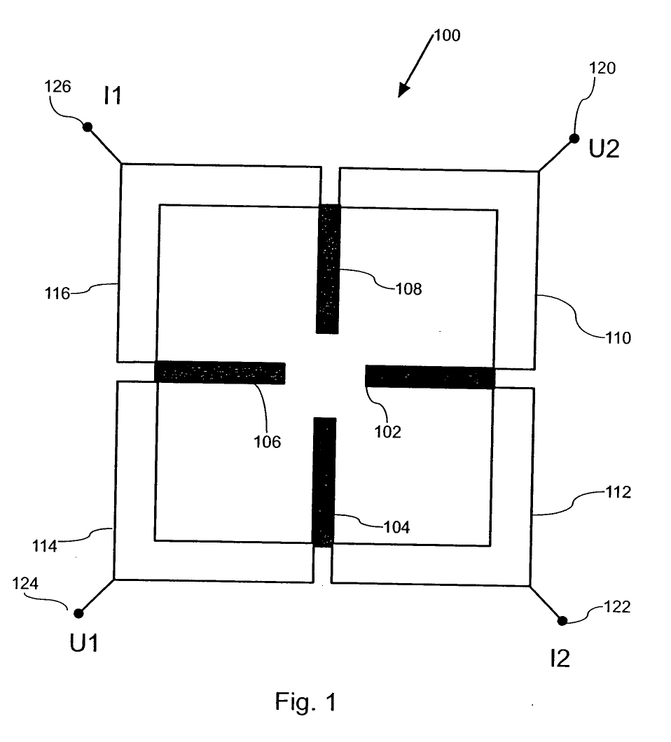

FIG. 1 shows a magnetic sensor 100 without flux guides. Therefore FIG. 1 only illustrates the electrical part of the magnetic sensor. The magnetic sensor 100 has four magnetoresistive elements 102, 104, 106, 108 that are connected via electrical conductors 110, 112, 114 and 116. Furthermore, the electrical circuit has four electrical connects 120, 122, 124 and 126.

The magnetoresistive elements are arranged in two pairs of two magnetoresistive elements featuring the same geometry, electrical properties as well as magnetic sensitivity. One pair of magnetoresistive elements has the horizontally aligned magnetoresistive elements 102 and 106 and the other pair of magnetoresistive elements has the vertically aligned magnetoresistive elements 108 and 104. Magnetoresistive element 102 is connected to magnetoresistive element 104 via the electrical conductor 112. Magnetoresistive element 102 is further connected to magnetoresistive element 108 via the electrical conductor 110. Magnetoresistive element 108 is further connected to magnetoresistive element 106 via the electrical conductor 116 and the magnetoresistive element 106 is connected to the magnetoresistive element 104 via the electrical conductor 114.

In this way the four magnetoresistive elements are electrically connected in a bridge circuit. Furthermore, the electrical conductor 110 has an electrical connect 120, the electrical conductor 112 has an electrical connect 122, the electrical conductor 114 has an electrical connect 124 and the electrical conductor 116 has an electrical connect 126.

Applying an electric current to the electrical connect 126 and 122 allows to measure a voltage across the magnetoresistive element 102 and 104 or across the magnetoresistive element 108 and 106 by connecting the electrical connects 120 and 124 to a voltage meter. In this way, the arrangement of magnetoresistive elements 102, 104, 106 and 108, electrical conductors 110, 112, 114 and 116 and electrical connects 120, 122, 124 and 126 represents a Wheatstone bridge.

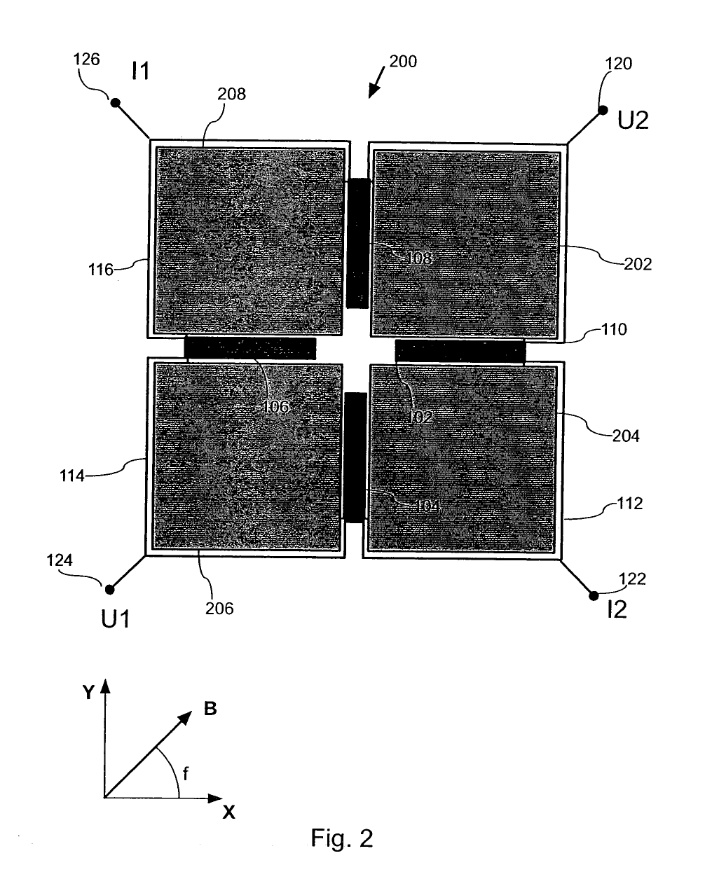

FIG. 2 illustrates the electric circuit 100 of FIG. 1 in combination with four soft-magnetic areas 202, 204, 206, and 208 serving as flux guides. The combination of the soft-magnetic areas 202, 204, 206, and 208 with the electric circuit 100 results in the inventive magnetic sensor. In the embodiment shown in FIG. 2 the soft-magnetic areas 202, 204, 206 and 208 feature a quadratic shape and are closely spaced with respect to each other in order to form four elongated gaps. The magnetoresistive elements 102, 104, 106 and 108 are positioned along these four elongated gaps separating the soft-magnetic areas 202, 204, 206 and 208. Here the pair of magnetoresistive elements 108 and 104 and their corresponding gaps are oriented along the vertical y-direction whereas the pair of magnetoresistive elements 106, 102 is oriented along the horizontal x-direction.

Applying an external magnetic field at an angle φ with respect to the horizontal x-direction leads to a corresponding magnetization of the soft-magnetic areas 202 . . . 208. Depending on the geometry and the arrangement of the soft-magnetic areas, hence the flux guides, the magnetic field in between the soft-magnetic areas; i.e., in the gaps, is amplified. Only those components of the magnetic field are amplified pointing in the direction perpendicular to the elongation of the corresponding gap. Therefore the magnetoresistive elements 108 and 104 only detect horizontal components, x-components of the externally applied magnetic field and the magnetoresistive elements 106 and 102 only detect vertical y-components of the externally applied magnetic field.

Making use of GMR-multilayer systems as magnetoresistive elements, the electrical resistance of magnetoresistive element 108 maximizes and the electrical resistance of magnetoresistive element 102 minimizes when the externally applied magnetic field points in the vertical direction, φ(=90°. Applying the electrical connectors 126 and 122 with an electrical current allows the measurement of a voltage drop across magnetoresistive elements 108 and 106. The resulting electrical signal is directly indicative of the difference of the electrical resistance of magnetoresistive element 108 and magnetoresistive element 106. When the externally applied magnetic field is rotated by an angle of 45° its vertical and horizontal components become equal in magnitude, hence the electrical resistance of the magnetoresistive elements 108 and 106 becomes substantially equal and the resulting voltage drop that is measured between electrical connect 120 and 124 equals to zero.

In this way, conventional GMR-multilayer systems can be used to detect not only the magnitude but also the direction of an applied magnetic field. Making use of the inventive arrangement of flux guides, the difference between the absolute x-component of the externally applied field and the absolute y-component of the externally applied field can effectively be measured. When the magnitude of the externally applied field remains constant, the direction of the external field can be determined. It is due to the geometric arrangement of flux guides that the magnitude of an amplified magnetic field between closely spaced flux guides varies with the direction of the magnetic field. Preferably, the geometry of the flux guides is appropriately designed in order to provide a desired gain factor for the amplification of the magnetic field to be detected inside the gaps separating the single flux guides. In this way, the sensor can be designed for a vast range of magnetic field magnitudes. It is only to be ensured that the magnetic field in the gaps between the flux guides is in the dynamic range of the GMR-multilayer systems in use.

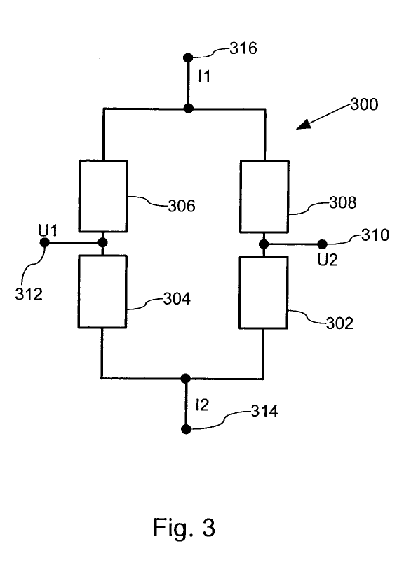

FIG. 3 shows a circuit diagram 300 of a Wheatstone bridge corresponding to the magnetic sensor 200 illustrated in FIG. 2. The magnetoresistive elements 102, 104, 106 and 108 are illustrated as electrical resistors 302, 304, 306, 308 that are interconnected by a bridge circuit. Typically, an electric current is applied to the electrical connects 314 and 316 and a voltage signal can be measured between the electrical connects 310 and 312. When all four electrical resistors 302, 204, 306 and 308 feature the same electrical resistance, the bridge is in balance; i.e., the voltage signal to be measured between the electrical connects 312 and 310 equals zero. This is typically the case, when the direction of the magnetic field is 45° with respect to the orientation of the magnetoresistive elements 102, 104, 106 and 108 or when no external magnetic field is applied. Rotating the external magnetic field with respect to the detectors leads to an imbalance of the bridge circuit and consequently the voltage signal between the electrical connects 310 and 312 becomes non-zero.

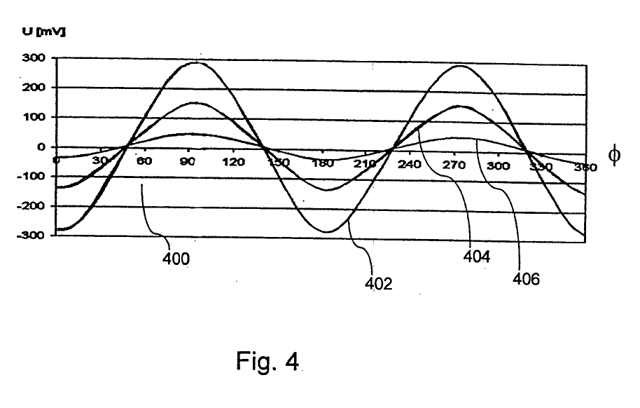

FIG. 4 shows a measured diagram illustrating a voltage signal between the electrical connects 310 and 312 of FIG. 3 versus the relative rotation angle between the externally applied magnetic field and the magnetic sensor. The diagram 400 shows three graphs 402, 404 and 406 of three magnetic fields that are different in magnitude. The magnet field of the graph 402 was 15 mT, the magnet field of graph 404 was 5 mT and the graph 406 corresponds to a magnet field of 2 mT. Even though the single graphs 402, 404 and 06 correspond to magnet fields that are different in magnitude, the three graphs feature a similar shape resembling a sinusoidal function. All three graphs have zero crossings near 450, 1350, 225° and 315° of rotation angle. Furthermore, the three curves have minima near 00 and 180° as well as maxima near 90° and 2700. Hence all three graphs resemble a shifted sinusoidal function with a periodicity of 180°.

Furthermore, it is obvious that by measuring the voltage signal, the angle of relative rotation between the sensor and the externally applied magnet field can unequivocally be determined only over a range of 0° to 90°. Making use of a second sensor oriented at a fixed angle with respect to the first sensor provides a second, shifted voltage signal allowing for the unequivocal determination of the rotation angle over a range from 0° to 180°. Other techniques to determine the rotation angle unequivocally over a range from O⁰ to 360° are known in the prior art and can correspondingly by applied here.

By counting the zero crossings of the voltage signal during a continuous rotation of the magnetic field, the sensor provides an efficient approach to realize a rev meter.

It is obvious from the diagram 400 that each successive zero crossing represents a rotation of 90°.

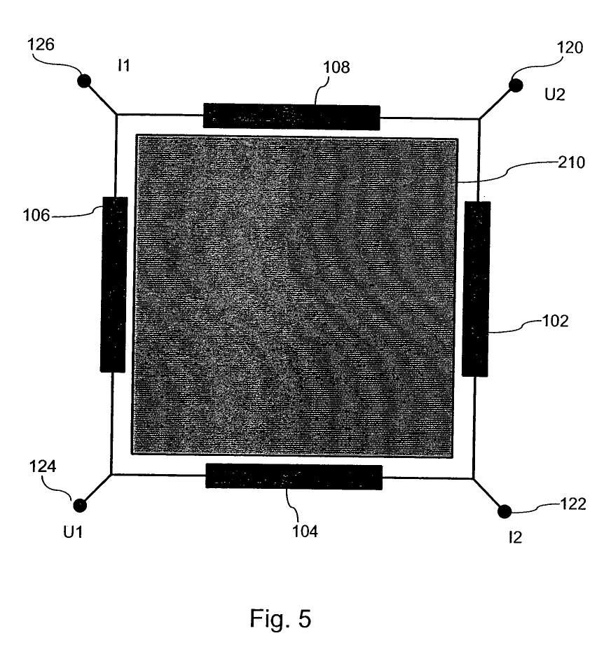

FIG. 5 shows a Wheatstone bridge arrangement of four magnetoresistive elements 102, 104, 106, 108 being interconnected in the same way as illustrated in FIG. 2. In contrast to FIG. 2 and FIG. 1, the embodiment of FIG. 5 only comprises a single flux guide 210 and the magnetoresistive elements are positioned near the edges of the flux guide 210. Also here, adjacently positioned magnetoresistive elements are oriented substantially perpendicular with respect to each other and oppositely positioned pairs 102, 106 and 104, 108 of magnetoresistive elements are substantially parallel with respect to each other. The electrical connects 126 and 122 are adapted to supply an electric current and the electrical connects 120, 124 serve as electrical connects in order to measure a voltage drop across magnetoresistive elements 108 and 106 and/or magnetoresistive elements 102 and 104.

1. A sensor for determining the direction of a magnetic field comprising:
a soft-magnetic planar structure with at least a first and a second area being separated by at least a first and a second elongated gap, the first and the second elongated gaps being non-parallel; and
at least a first and a second magnetoresistive element, the first magnetoresistive element being positioned along the first elongated gap and the second magnetoresistive element being positioned along the second elongated gap, the first and the second magnetoresistive elements being adapted to be electrically connected to a source of electrical energy and to an electrical measurement unit.

2. The sensor according to claim 1, wherein the at least first and second magnetoresistive elements are adapted to provide at least one electrical signal to the electrical measurement unit, the at least one electrical signal being indicative of the relative angle between the direction of the magnetic field and the orientation of the at least first and second magnetoresistive elements.

3. The sensor according to claim 1, wherein the at least first and second areas have a point of contact.

4. The sensor according to claim 1, wherein the soft-magnetic planar structure comprises four soft-magnetic areas of rectangular shape being closely adjacently spaced forming a first and a second pair of elongated gaps, each of which having two substantially parallel oriented oppositely positioned elongated gaps, the first and the second pair of gaps being oriented substantially perpendicular with respect to each other, the sensor comprising four magnetoresistive elements being positioned along the four elongated gaps.

5. The sensor according to claim 4, wherein the four magnetoresistive elements are electrically interconnected to form a bridge circuit being adapted to provide an electrical signal being indicative of a difference between two substantially perpendicular components of the magnetic field.

6. The sensor according to claim 1, wherein the magnetoresistive elements exhibit a GMR or an AMR effect or a TMR effect.

7. A sensor for determining the direction of a magnetic field comprising:
a soft-magnetic planar structure with an area having at least a first and a second edge being non-parallel; and
at least a first and a second magnetoresistive element, the first magnetoresistive element being positioned along the first edge and the second magnetoresistive element being positioned along the second edge, the first and the second magnetoresistive elements being adapted to be electrically connected to a source of electrical energy and to an electrical measurement unit.

8. A sensor device for determining the direction of a magnetic field, the sensor device comprising:
at least a first sensor and a second sensor, wherein the at least first sensor and the second sensor each comprise:
a soft-magnetic planar structure with an area having at least a first and a second edge being non-parallel; and
at least a first and a second magnetoresistive element, the first magnetoresistive element being positioned along the first edge and the second magnetoresistive element being positioned along the second edge, the first and the second magnetoresistive elements being adapted to be electrically connected to a source of electrical energy and to an electrical measurement unit;
wherein the first and the second sensors are arranged in parallel planes, the first sensor being rotated with respect to the second sensor.

9. A signal processing system for determining the direction of a magnetic field, comprising signal processing means for determining the direction of a magnetic field by processing of an electrical signal provided by an electrical measurement unit, the electrical measurement unit being adapted to be electrically connected to at least a first and a second magnetoresistive element, the at least first magnetoresistive element being positioned along an at least first elongated gap and the at least second magnetoresistive element being positioned along an at least second elongated gap, the at least first and the second elongated gaps separating at least a first and a second area of a soft-magnetic planar structure, the first and the second elongated gaps being non-parallel.

10. The signal processing system according to claim 9, wherein the electrical signal is indicative of the relative angle between the direction of the magnetic field and the orientation of the at least first and second magnetoresistive elements.

11. The signal processing system according to claim 9, further comprising input means being adapted to modify the signal processing means to a variety of geometries of the soft-magnetic planar structure.

12. The signal processing system according to claim 9, wherein the electrical measurement unit providing the electrical signal to the signal processing system being further adapted to be electrically connected to a bridge circuit, the bridge circuit having four magnetoresistive elements that are electrically interconnected and being positioned along a first and a second pair of elongated gaps, each of which having two substantially parallel oriented oppositely positioned elongated gaps, the first and the second pair of gaps being oriented substantially perpendicular with respect to each other.

13. The signal processing system according to claim 12, wherein the electrical signal provided by the electrical measurement unit is indicative of a difference between two substantially perpendicular components of the magnetic field, the signal processing system comprising signal processing means for determining the direction of a magnetic field by processing of an electrical signal provided by an electrical measurement unit.

14. The signal processing system according to claim 12, further comprising signal processing means for detecting a zero-crossing of the electrical signal.

15. The signal processing system according to claim 9 further comprising a computer program for calculating the direction of the magnetic field from an electrical signal provided by the electrical measurement unit.

16. The signal processing system according to claim 15 further comprising program means for detecting a zero-crossing of the electrical signal.
